(19) United States
(12) Patent Application Publication
(10) Pub. No.: US 2007/0056896 A1
(43) Pub. Date: Mar. 15, 2007

(54) Method and apparatus for remediating bulk material contaminated with a heavy metal

(75) Inventor: Noel E. Spindler, Hamburg, NJ (US)

Correspondence Address: CHRISTIE, PARKER & HALE, LLP, PO BOX 7068, PASADENA, CA, 91109-7068, US

(73) Assignee: SOLUCORP INDUSTRIES, LTD.

(21) Appl. No.: 11/518,047

(22) Filed: Sep. 8, 2006

Related U.S. Application Data
(60) Provisional application No. 60/716,004, filed on Sep. 9, 2005.

(51) Int. Cl. B01D 33/04

(52) U.S. Cl. 210/400

(57) ABSTRACT

A method and apparatus for remediating a bulk material contaminated with a heavy metal are provided. The apparatus includes receptacles for contaminated material and a heavy metal remediation agent; a chamber coupled to each of the receptacles; a valve between each receptacle and the chamber; a port for introducing water into the chamber; and a mixer coupled to the chamber. Heavy metal waste is remediated by loading wet or dry contaminated material into a receptacle, metering a predetermined amount of the contaminated material into a chamber coupled to the receptacle; loading a heavy metal-remediation agent into a second receptacle coupled to the chamber; metering a predetermined amount of the heavy metal-remediation agent from the second receptacle into the chamber; introducing water into the chamber; directing the contaminated material, heavy metal-remediation agent, and water into a mixer and mixing same therein; and discharging the resulting treated material into a receptacle.

### CROSS-REFERENCE TO RELATED APPLICATION(S)

This U.S. patent application claims the priority benefit of U.S. Provisional Patent Application No. 60/716,004, filed Sep. 9, 2005, the entire contents of which are incorporated by reference herein.

### FIELD OF THE INVENTION

The invention relates generally to remediation of heavy metals and, more particularly, to methods and apparatus for treating wet and dry bulk materials contaminated with a heavy metal.

### BACKGROUND OF THE INVENTION

Heavy metals such as lead, zinc, and chromium are found in certain paints and encountered in a number of industrial applications. In the painting industry, such materials are often used as pigments and in the production of anti-corrosion paints used to protect the metal surfaces of structures, airplanes, boats, and other vehicles. Lead-based paints, although disfavored for many applications, continue to be used in some industries, and such paints are still found in a number of commercial, industrial, and even residential settings. Zinc chromate is widely used in alkyd, epoxy, and polyurethane primers in the aerospace industry, because of its ability to protect aluminum, its thermal stability, and its ability to withstand thermal shock experienced by airplanes.

For such uses, it is not easily substituted . Unfortunately, zinc chromate and other heavy metal-containing paints, materials, and their dust are toxic.

When heavy metal-containing primers and paints are removed, and whenever bulk materials containing heavy metals are processed or moved, dusts and aerosols are produced, and the waste stream must be controlled. FIG. 1 shows a conventional baghouse for collecting particulate matter, such as the residue of a sandblasting paint removal operation. Incoming material from a sandblasting operation (i.e., garnet dust and paint residue) is conveyed through a vacuumized carrier system (not shown) to the baghouse 1, where the particular matter is filtered by a number of filter bags Periodically, a shaking mechanism causes particulate matter that has collected on the bags to shake loose, where it falls into the hoppers 2 at the bottom of the baghouse.

The hoppers are connected to a pair of collection drums 3, via slide gates 4. Although the mechanism captures the contaminated paint residue, it does nothing to remediate it. The drums become filled with heavy metals, which can't be disposed of without treatment.

The safe treatment and disposal of such waste is regulated in most jurisdictions. Disposing of heavy metal-contaminated material in a landfill is environmentally irresponsible, as exposure to ground water, wind, rain, or other environmental conditions, can cause heavy metals to leach into the surrounding area. There is a substantial, continuing need for improved methods and apparatus for remediating heavy metals in wet and dry bulk materials, especially on site at locations where such materials are generated, processed, or removed.

### SUMMARY OF THE INVENTION

According to the invention, an apparatus and a method for remediating heavy metal waste are provided. In a first aspect of the invention, an apparatus comprises a receptacle for wet or dry material contaminated with a heavy metal; a receptacle for a heavy metal remediation agent; a chamber coupled to each of the receptacles; a valve between each receptacle and the chamber; a port for introducing water into the chamber; and a mixer coupled to the chamber, where the heavy metal-containing material, remediation agent, and water can be mixed. In one embodiment, the apparatus further comprises a drum or other receptacle for collecting treated material discharged from the mixer.

In a second aspect of the invention, a method for remediating heavy metal waste is provided and comprises loading wet or dry material contaminated with a heavy metal into a receptacle, metering a predetermined amount of the contaminated material into a chamber coupled to the receptacle; loading a heavy metal-remediation agent into a second receptacle coupled to the chamber; metering a predetermined amount of the heavy metal-remediation agent from the second receptacle into the chamber; introducing water into the chamber; directing the contaminated material, heavy metal-remediation agent, and water into a mixer and mixing same therein; and discharging the resulting treated material into a receptacle.

### BRIEF DESCRIPTION OF THE DRAWINGS

Various features and advantages of the invention will become better understood when reference is made to the following detailed description and considered in light of the accompanying drawings, wherein:

FIG. 1 is an illustration of a prior art baghouse for collecting particulate matter, such as garnet dust paint blasting media and paint residue;

FIG. 2 is a front view of part of an apparatus for remediating bulk material contaminated with a heavy metal, according to one embodiment of the invention;

FIG. 3 is a side view of an another part of the apparatus depicted in FIG. 2; and

FIG. 4 is a side view of the apparatus shown in FIGS. 2 and 3, depicted as a replacement for a slide gate assembly linking a baghouse hopper to a collection drum.

### DETAILED DESCRIPTION OF THE INVENTION

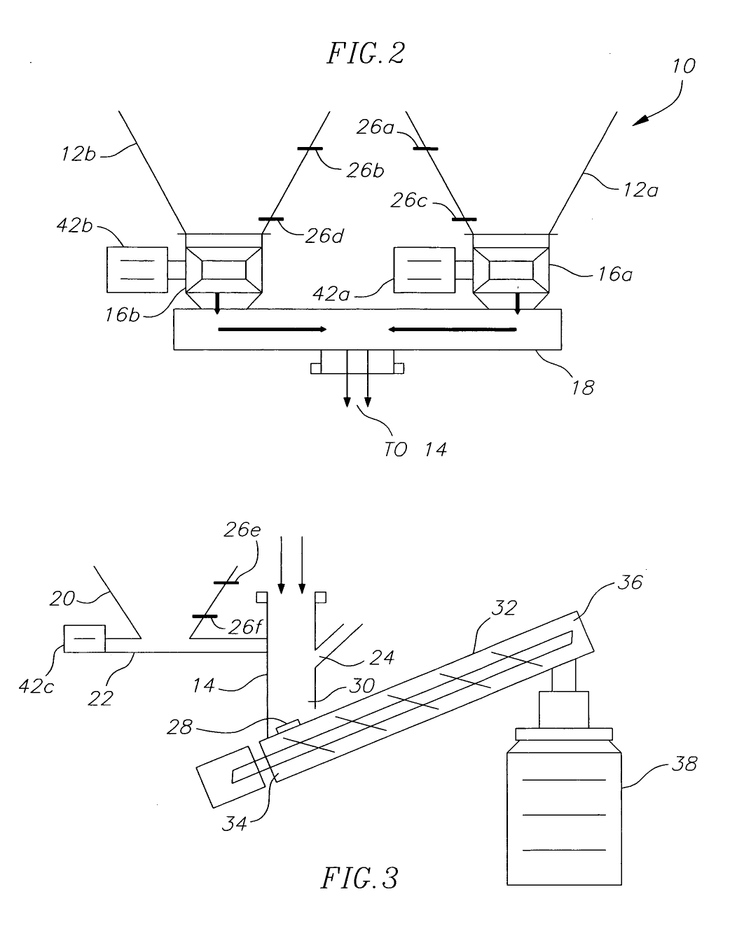

FIGS. 2-4 illustrate one embodiment of an apparatus for remediating material contaminated with a heavy metal, in accordance with the invention. The apparatus 10 includes a pair of hoppers 12a, 12b coupled to a chamber 14 via valves 16a, 16b and a cross auger 18 (essentially, a pair of augers that conveys material toward a common center). A third hopper 20 is also coupled to the chamber 14 via an auger 22. The chamber can be coupled to a water injector (not shown) or simple water line (not shown) through a port 24 in the chamber 14. Sensors 26a-e in the hoppers detect the high and low level of materials loaded therein. A port 28 in the bottom 30 of the chamber allows matter (i.e., heavy metal-contaminated material, water, and remediation agent) to exit into a mixer 32. In the embodiment shown, the mixer is an auger, and the chamber is coupled to the auger's lower end 34. The opposite (upper) end 36 of the mixer 32 is coupled to a collection drum 38 or other vessel. Optionally, a slide gate (not shown)is located between the discharging end 36 of the mixer and the collection drum 38.

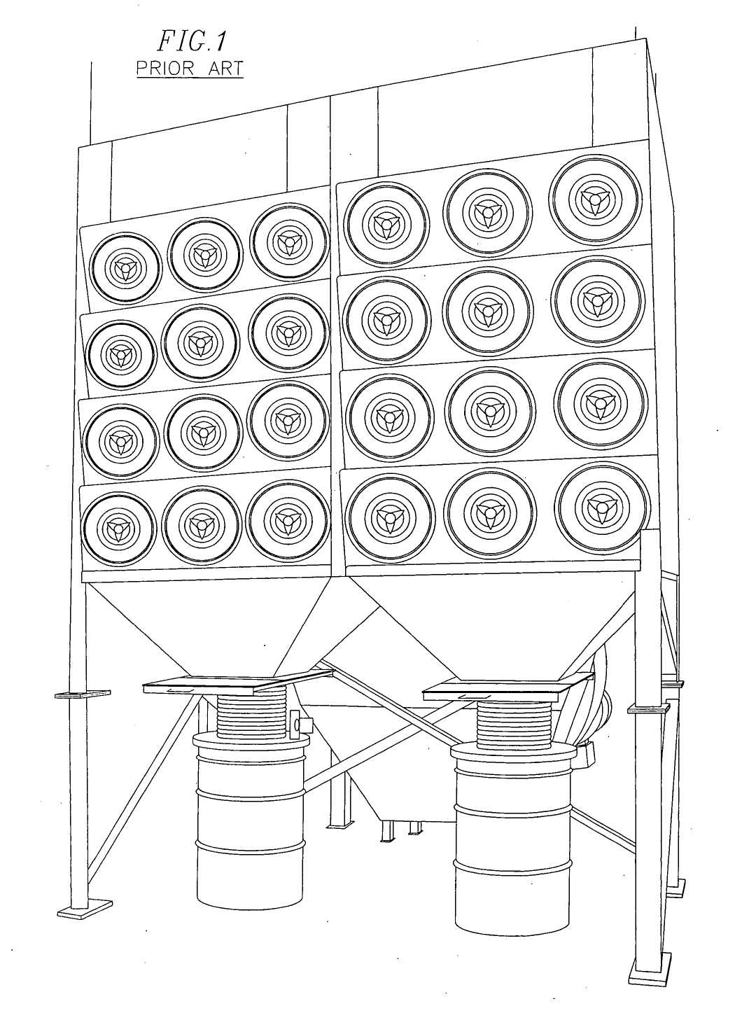

The hoppers are coupled to the chamber either directly or, more preferably, via valves that enable material to be discharged into the chamber in a metered or controlled manner. For example, in FIG. 1, the valves 16a, 16b are metering valves, each driven by a motor 42a, 42b. Alternatively, other types of valves can be used, so long as they are suitable for use with the type of material being handled: wet and/or dry, finely divided, corrosive, etc. In a preferred embodiment, the apparatus also includes rotary airlocks associated with the valves 16a, 16b coupled to the hoppers receiving heavy metal-containing material, to minimize or prevent fine dust and aerosols from escaping.

Advantageously, each of the drive motors for the valves 16a, 16b and auger 22 are linked to at least one sensor in a particular hopper, and more preferably to a pair of high/low sensors in each hopper. Thus, sensors 26a and 26c are linked to motor 42a; sensors 26b and 26d are linked to motor 42b; and sensors 26e and 26f are linked to motor 42c. Nonlimiting examples of suitable sensors include proximity sensors, “high/low” sensors, capacitive level sensors, and the like, their primary function being to detect material as it reaches or falls below a desired level within a hopper. Nonlimiting examples of motor-to-sensor links include electrical, optical, infrared, and wireless (e.g., radiofrequency) links. In one embodiment, the motors and sensors are further linked to a microprocessor (not shown), which is programmed to control operation of the motors in response to the level of material in the hoppers detected by the sensors.

Using a cross auger rather than a pair of conduits that converge toward the chamber 14 gives the apparatus a smaller vertical profile. This enables an existing baghouse (such as the one shown in FIG. 1) to be retrofitted with a heavy metal stabilization unit (a subassembly consisting of the metering valves, cross auger, chamber, remediation agent hopper, auger, water injector or water line, and all valves, airlocks, sensors, and any additional parts and components) with little difficulty. The slide gates 4 are disconnected from the baghouse 1, sensors are installed in the hoppers, and the subassembly is installed and coupled to the dust hoppers and the collection drums (optionally retaining the slide gates).

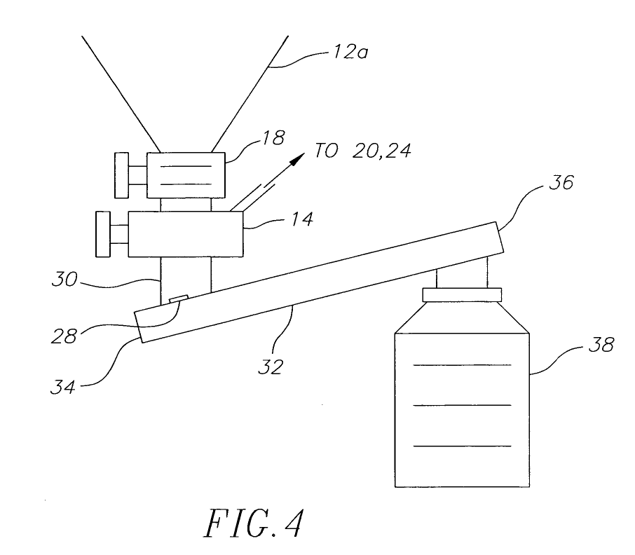

In FIG. 3, the third hopper 20 (into which a remediation agent can be loaded) is coupled to the chamber 14 by an auger 22, which is driven by a motor 42c. This configuration reduces the vertical profile of the apparatus. In an alternate embodiment, the third hopper is coupled to the chamber by a motor-driven metering valve and a short conduit that enters the chamber at a slight to moderate downward angle.

To operate the apparatus, wet or dry material contaminated with a heavy metal, such as sandblasted lead-based paint residue, other bulk powder, aggregate, dust, dirt, sludge, slag, etc., is loaded into the pair of hoppers 12a, 12b, either manually or, more preferably, using machinery, or via discharge from another apparatus (such as the output from a baghouse). A remediation agent capable of “fixing” the heavy metal (described below) is loaded into the third hopper 20. When sufficient material and remediation agent have been loaded into the hoppers (as determined by the sensors), the valves are actuated by the drive motors, and the contaminated material and remediation agent are discharged into the chamber in a controlled fashion, so that predetermined amounts of contaminated material and remediation agent are loaded into the chamber. Water is introduced into the chamber though the water port 24. Some mixing of contaminated material and remediation agent may occur as the chamber is loaded with components.

More thorough mixing takes place in the mixer 32, which is coupled to the port 28 in the bottom of the chamber. In the embodiment shown in FIGS. 3 and 4, the mixer is another auger —essentially an encased, rotating screw. The amount of mixing can depend on the time the material spends in the mixer, sometimes referred to as the “residence time” or the “dwell time.” Factors that affect the residence time in the mixer include auger length and volume, speed of rotation of the auger's screw, number of screw “flights,” flight width, flight pitch, separation between flights, etc. In a preferred embodiment, the auger is configured and operated in a manner that causes thorough (substantially homogeneous) mixing of the matter that passes through the mixer, as determined by at least a visual inspection of the matter discharged from the auger's upper end 36.

As used herein, the term “heavy metal remediation agent” (or simply, “remediation agent”) refers to a substance that is capable of “fixing” a heavy metal, either by transforming it to a less water-soluble form and/or by otherwise rendering the heavy metal substantially non-leachable (i.e., by encapsulating the metal in a substantially non-leachable matrix). Preferably, the remediation agent is capable of reducing the water-solubility of a heavy metal below the maximum amount permitted by statute, e.g., the U.S.-U.T.S. limits. The remediation agent is loaded into the hopper in pellet, flake, free-flowing powder, slurry, or some other suitable form. In the presence of water, the remediation agent interacts with heavy metals in the contaminated material and remediates the heavy metals—typically by causing them to precipitate, and/or by encapsulating the metals in an insoluble, cement—like matrix (when the treated material has dried).

The particular remediation agent selected to remediate a given material can depend on a number of factors, including the heavy metal(s) contaminating the bulk material, the amount of heavy metal present, the identity and amount of other elements and compounds present, and so forth. Nonlimiting examples of remediation agents include calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium- containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, metal sorbing clays, such as Bentonite and Fuller's Earth, and mixtures thereof. The mineral apatite, Ca₅(PO₄)₃(F,Cl,OH), is functional, but slow. Alkaline earth silicates (e.g., calcium silicate), operate through sorption and as a consequence of their high alkalinity; hence, their effect is likely not permanent. When used by themselves, phosphates are considered suitable for remediation of lead, but they do not remediate other metals. Indeed, application of phosphates to arsenic can actually aggravate leaching.

In general, mixtures of the above-listed agents are preferred, especially mixtures of a sulfide, a carbonate and/or hydroxide, and a phosphate. Most heavy metal sulfides are water-insoluble. The presence of carbonates and phosphates (in particular) is believed to have a pH buffering effect, and/or minimizes subsequent redox reactions, thereby preserving the metal sulfide precipitate over an extended range of pH and other conditions. For materials contaminated with lead, a combination of calcium sulfide, calcium carbonate, and triple super phosphate is preferred. “Triple super phosphate” (TSP) is Ca(H₂PO₄)₂.H₂O (CAS No. 65996-95-4).

A particularly preferred remediation agent is MBS™ 2.1, a Molecular Bonding System™ brand remediation agent available from Solucorp Industries (West Nyack, NY). MBS™ 2.1 is a 3:2:1 (wt/wt) mixture of calcium carbonate/calcium sulfide/triple super phosphate. This reagent is capable of rendering insoluble harmful metals to concentrations below their U.S. Universal Treatments Standard (UTS) limits.

MBS™ 2.1 is not pH-dependent, and can remediate lead under conditions ranging from pH 1 to pH 13. In contrast, phosphates and silicates are pH-dependent, with phosphates functional under broadly neutral conditions (pH 6 to 8), and silicates functional under strongly alkaline conditions (>pH 10). Additionally, the MBS™ remediation agent converts soluble lead salts to lead sulfide, which is non-toxic by oral administration. Thus, its use should detoxify lead particulates.

The amount of remediation agent to be employed depends on a number of factors, including the identity, type, and amount of heavy metal(s) present (or suspected of being present) in the material to be remediated, and the choice of remediation agent. For example, bulk material that leaches 800mg metal/liter requires more remediation agent than material that leaches 50 or 100mg metal/liter. Bulk material containing metals in a highly oxidized state (e.g., chromium VI), can require treatment with more remediation agent, due to the higher reducing power that is required. As a general rule of thumb, the amount of remediation agent employed can range from about 2-30% wt/wt, based on the combined weight of remediation agent and bulk material being treated. As a nonlimiting example, the bulk material produced when lead-based paint is sandblasted (sometimes called “garnet dust”) can be effectively treated with 5% (wt/wt) MBS 2.1 and sufficient water to form an aqueous slurry.

As another example, conducted without using the apparatus described herein, it has been found that 100 grams of chromium (VI) paint residues contained within a 10 cm square section of a paint filter leaching 800 mg/Litre chromium (VI) (determined by TCLP) can be treated with 50 gram of MBS 2.1 in an aqueous slurry, thereby reducing the amount of leaching to 20 mg/Litre chromium (VI). In contrast, treatment with an amount of MBS remediation agent equal to the amount of paint residues trapped in the filter renders leaching to less than the UTS limit of 0.6 mg/Litre total chromium. Other wastes, for example those based on lead or zinc, require less MBS reagent.

Optionally, one or more surfactants, dispersing aids, flocculating agents, and/or other processing aids are also introduced into the chamber. They can be added to the remediation agent hopper, the water injection port, and/or introduced through another port (not shown) in the chamber.

Although the invention has thus far been described with reference to various embodiments and examples, it is not limited thereto. A number of variations and modifications can be made, consistent with the invention. For example, instead of a pair of hoppers for receiving heavy metal-contaminated material, a single hopper, or multiple hoppers, can be used. Similarly, the remediation agent can be delivered to the chamber 14 by more than a single hopper. (For example, the various components of MBS™ 2.1 —calcium carbonate/calcium sulfide/triple super phosphate—could each be delivered to the chamber through a separate hopper.) Rather than using an auger 22 to deliver remediation agent to the chamber, a metering valve (optionally in combination with a rotary airlock) can be utilized. The invention is limited only by the claims appended hereto and their equivalents.

WHAT IS CLAIMED IS:

1. An apparatus for remediating heavy metal waste, comprising;
a receptacle for wet or dry material contaminated with a heavy metal;
at least one sensor in the receptacle;
a receptacle for a heavy metal remediation agent;
a chamber coupled to each of the receptacles;
a valve between each receptacle and the chamber;
a port for introducing water into the chamber; and
a mixer coupled to the chamber, where the heavy metal-containing material, remediation agent, and water can be mixed.

2. An apparatus as recited in claim 1, wherein the receptacle for wet or dry material contaminated with a heavy metal comprises at least one hopper.

3. An apparatus as recited in claim 1, wherein the receptacle for wet or dry material contaminated with a heavy metal comprises a pair of hoppers.

4. An apparatus as recited in claim 1, wherein the at least one sensor can detect material as it reaches or falls below a desired level within the receptacle for a heavy metal remediation agent.

5. An apparatus as recited in claim 1, wherein the at least one sensor comprises a pair of high/low level sensors.

6. An apparatus as recited in claim 1, wherein each valve is a motor-driven metering valve.

7. An apparatus as recited in claim 1, further comprising a rotary airlock associated with the valve between the receptacle for wet or dry material contaminated with a heavy metal and the chamber.

8. An apparatus as recited in claim 1, wherein the mixer comprises an auger.

9. An apparatus as recited in claim 1, further comprising at least one sensor in the receptacle for a heavy metal remediation agent.

10. An apparatus for remediating heavy metal waste, comprising:
a chamber;
a pair of hoppers, each hopper coupled to the chamber via a motor-driven metering valve and a cross auger;
a third hopper, coupled to the chamber via an auger;
a port in the chamber for introducing water into the chamber;
at least one sensor in each of the pair of hoppers and the third hopper; and
a motor-driven mixer coupled to the chamber through a port in the chamber that allows matter to pass through to the mixer.

11. A method for remediating heavy metal waste, comprising:
loading wet or dry material contaminated with a heavy metal into a receptacle;
metering a predetermined amount of the contaminated material into a chamber coupled to the receptacle;
loading a heavy metal-remediation agent into a second receptacle coupled to the chamber;
metering a predetermined amount of the heavy metal-remediation agent from the second receptacle into the chamber;
introducing water into the chamber;
directing the contaminated material, heavy metal-remediation agent, and water into a mixer;
mixing the contaminated material, heavy metal-remediation agent, and water; and;
discharging the resulting treated material into a receptacle.

12. A method as recited in claim 11, wherein the heavy metal-remediation agent is selected from the group consisting of calcium sulfide, calcium phosphate, calcium hydroxide, calcium carbonate, calcium oxide, magnesium sulfide, magnesium phosphate, magnesium hydroxide, magnesium carbonate, magnesium oxide, mixed calcium- and magnesium-containing carbonates and phosphates, apatite, di-calcium hydrogen phosphate, calcium di-hydrogen phosphate, triple super phosphate, dolomite, phosphoric acid and its salts, calcium-X-phosphates (where X is a metal ion), alkaline earth silicates, hydrated silica, hydrated alumina, metal sorbing clays, such as Bentonite and Fuller's Earth, and mixtures thereof.

13. A method as recited in claim 11, wherein the heavy metal-remediation agent comprises a mixture of calcium carbonate, calcium sulfide, and triple super phosphate.

14. A method as recited in claim 13, wherein the heavy metal-remediation agent comprises a 3:2:1 (wt/wt) mixture of calcium carbonate, calcium sulfide, and triple super phosphate.

15. A method as recited in claim 11, further comprising introducing one or more surfactants, dispersing aids, flocculating agents, and/or other processing aids into the chamber.

16. A method as recited in claim 11, wherein the remediation agent comprises about 2-30% by weight of the combined predetermined amounts of remediation agent and contaminated material.
